(19) United States
(12) Patent Application Publication
(10) Pub. No.: US 2009/0097461 A1
(43) Pub. Date: Apr. 16, 2009

(54) METHOD AND APPARATUS FOR PROVIDING CONTENT IN WIRELESS COMMUNICATION NETWORK

(76) Inventors: Mustafa Ergen, Oakland, CA (US); Rehan Jalil, San Jose, CA (US)

Correspondence Address: GLOBAL IP SERVICES, PLLC, 10 CRESTWOOD LANE, NASHUA, NH, 03062, US

(21) Appl. No.: 12/248,969

(22) Filed: Oct. 10, 2008

Related U.S. Application Data
(60) Provisional application No. 60/998,572, filed on Oct. 11, 2007.

(51) Int. Cl. H04W 4/00

(52) U.S. Cl. 370/338; 370/401

(57) ABSTRACT

A method and apparatus for providing one or more contents to one or more devices in a wireless communication network. The method includes associating the one or more contents with one or more headers corresponding to one or more data packets transmitted for the one or more devices at an anchor datapath gateway in the wireless communication network The method further includes rendering the one or more contents with data represented by the one or more data packets to the one or more devices in response to associating the one or more contents with the one or more headers.

### RELATED APPLICATIONS

Benefit is claimed under 35 U.S.C. 119(e) to U.S. Provisional Applications Ser. No. 60/998,572 entitled “METHOD AND APPARATUS FOR PROVIDING CONTENT IN WIRELESS COMMUNICATION NETWORK” by Mustafa Ergen et al., filed on 11 Oct. 2007, which is herein incorporated in its entirety by reference for all purposes.

### FIELD OF THE INVENTION

The present invention generally relates to a wireless communication network. More specifically the present invention relates to providing one or more contents in the wireless communication network.

### BACKGROUND OF THE INVENTION

Wireless communication networks have gained utmost importance with the advent of portable communication devices such as web enabled mobile phones, laptop computers, personal digital assistants. Many professionals today depend on one or more wireless communication networks to access the internet while traveling, to reply to important emails or to submit urgent assignments. This need has been met by the one or more wireless communication networks in public modes of transport and at public places such as eateries, parks, malls, etc.

Generally, when a user of a device in a wireless communication network is provided a requested content, one or more additional content may be displayed with the requested content. Examples of one or more additional content may include, but are not limited to advertisements, promotional offers, and news. In some conventional systems, one or more additional content are randomly rendered with the requested content. However, they are not targeted to the user or are not related to a context of the requested content. Therefore, the user may ignore one or more additional content rendered on the device of the user.

In other conventional systems, one or more additional content are rendered by a content provider on the requested content as one or more of a pop-up window, an overlay, a prelude, an epilogue, and a banner. For example, an advertisement may be overlayed on a requested web page. Some users may consider the above mentioned methods of rendering additional content to be interfering with the requested content.

There is therefore a need for a method and system in which context specific additional content is rendered on a device of a user without causing any interference with the requested content.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram showing a wireless communication network in which various embodiments of the invention may function.

FIG. 2 is a block diagram showing an apparatus for providing one or more contents in a wireless communication network, in accordance with an embodiment of the invention.

FIG. 3 is a flowchart of a method of providing one or more contents in a wireless communication network, in accordance with an embodiment of the invention.

FIG. 4 is a flowchart of a method of providing one or more contents in a wireless communication network, in accordance with another embodiment of the invention.

FIG. 5 is a flowchart of a method of communication in a wireless communication network, in accordance with an embodiment of the invention.

FIG. 6 is a flowchart of a method of communication in a wireless communication network, in accordance with another embodiment of the invention.

FIG. 7 illustrates a method of displaying one or more contents on one or more devices in a wireless communication network, in accordance with an exemplary embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to providing one or more contents in a wireless communication network. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide methods and apparatuses for providing one or more contents in a wireless communication network. The method includes associating one or more contents with one or more headers corresponding to one or more data packets transmitted for one or more devices at an anchor datapath gateway in the wireless communication network. The method further includes, rendering the one or more contents with data represented by the one or more data packets to the one or more devices.

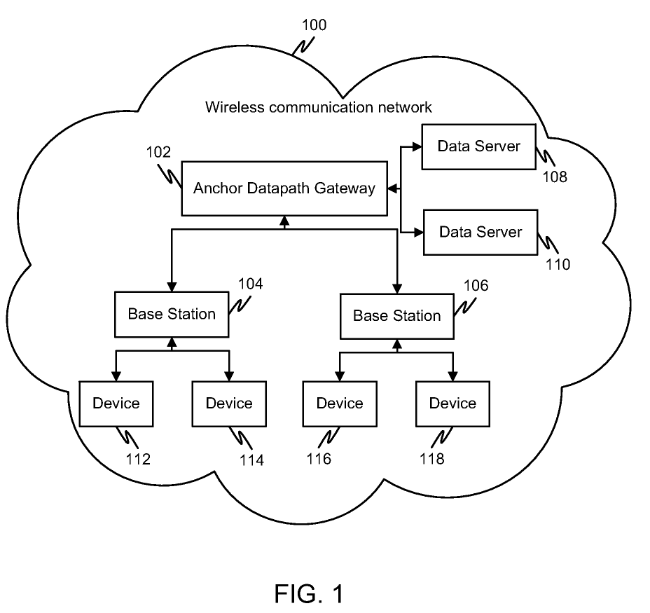

FIG. 1 is a block diagram showing a wireless communication network 100 in which various embodiments of the invention may function. Examples of wireless communication network 100 may include, but are not limited to, a Worldwide Interoperability for Microwave Access (WiMAX) communication network, a 3rd Generation Partnership Project (3GPP) network including 3GPP Long Term Evolution (LTE) network, a 3rd Generation Partnership Project 2 (3GPP2) network including 3GPP2 Ultra Mobile Broadband (UMB) network, a Wireless Fidelity (WiFi) network, and any variant of Orthogonal Frequency Division Multiple Access (OFDMA) communication network having a backhaul link.

Wireless communication network 100 includes an anchor datapath gateway 102, one or more Base Stations (BSs) (for example, a BS 104 and a BS 106, as shown in FIG. 1) and one or more data servers (for example, a data server 108 and a data server 110 as shown in FIG. 1). Anchor datapath gateway 102 may be an Access Service Network (ASN) controller, if wireless communication network 100 is a WiMAX communication network. It will be apparent to a person skilled in the art that wireless communication network 100 may include a plurality of anchor datapath gateways. The one or more BSs further communicate with one or more devices (for example, a device 112, a device 114, a device 116, and a device 118 as shown in FIG. 1). The one or more devices are used by one or more users. BS 104 communicates with device 112 and device 114. Similarly, BS 106 communicates with device 116 and device 118. Examples of a device may include, but are not limited to, Personal Computers (PC), laptops, mobile phones, Personal Digital Assistants (PDA), and personal communicators.

The one or more devices are used by the one or more users to request data from the one or more data servers. Data requests generated from the one or more devices are routed through the one or more BSs and anchor datapath gateway 102 to the one or more data servers, which are connected to anchor data path gateway 102. Thereafter, the one or more data servers provide data requested by the one or more users at the one or more devices through anchor datapath gateway 102 and the one or more BSs.

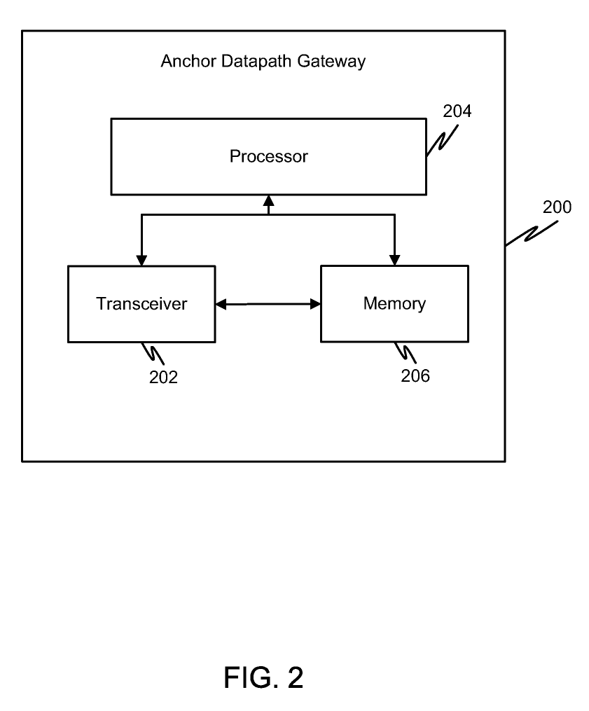

FIG. 2 is a block diagram showing an anchor datapath gateway 200 for providing one or more contents in wireless communication network 100, in accordance with an embodiment of the invention. Anchor datapath gateway 200 includes a transceiver 202 and a processor 204 coupled to transceiver 202. Transceiver 202 receives one or more data packets transmitted for one or more devices. The one or more data packets may be transmitted from one or more data servers in response to a data request sent from the one or more devices used by one or more users in wireless communication network 100.

Processor 204 may extract information corresponding to the one or more devices. Information corresponding to a device of the one or more devices may include, but is not limited to a location information of the device, a data requested by the device, a data downloaded by the device, a data uploaded by the device, and a data browsed by the device. Processor 204 may extract information corresponding to a device of the one or more devices from one or more of the one or more data packets received by transceiver 202. Alternatively, processor 204 may extract information corresponding to a device of the one or more devices from a set of data packets communicated between the device and the one or more data servers by transceiver 202. Also, processor 204 may extract information corresponding to a device of the one or more devices based on paging information of the device. The paging information of the device is used to track location of the device.

Processor 204 then stores information extracted for the one or more devices in a memory 206. Thereafter, based on information extracted for the one or more devices, processor 204 retrieves the one or more contents. The one or more contents may include one or more of, but are not limited to advertisements, news articles, weather reports, a location based information, and a multimedia presentation.

Processor 204 then associates the one or more contents with one or more headers corresponding to the one or more data packets. Thereafter, processor 204 renders the one or more contents with data represented by the one or more data packets to the one or more devices.

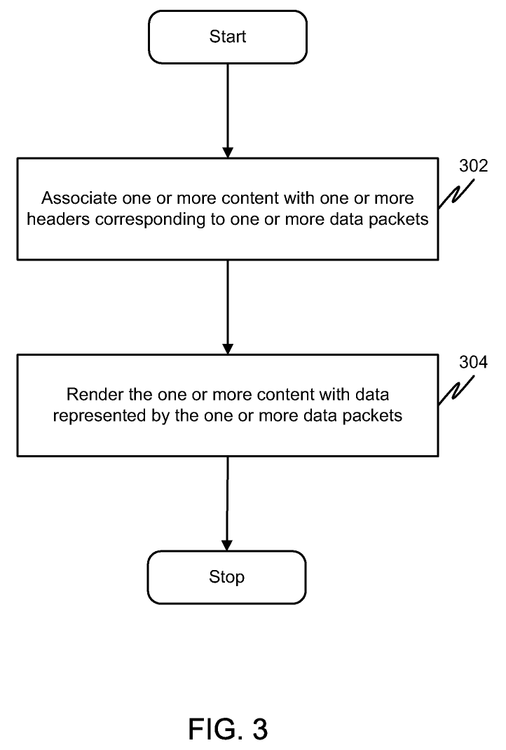

FIG. 3 is a flowchart of a method of providing one or more contents in wireless communication network 100, in accordance with an embodiment of the invention. In wireless communication network 100, a set of data packets is communicated between one or more devices and one or more data servers through anchor datapath gateway 200 by transceiver 202. In an embodiment, anchor datapath gateway 200 is an ASN controller, if wireless communication network 100 is a WiMAX communication network. Transceiver 202 receives one or more data packets transmitted for the one or more devices. The one or more data packets may be transmitted from the one or more data servers in response to a data request sent from the one or more devices used by one or more users.

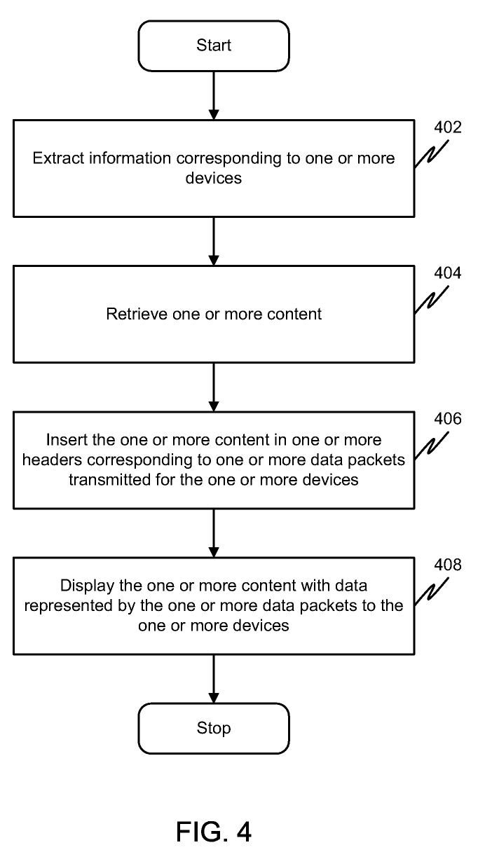

Processor 202 may extract information corresponding to the one or more devices at anchor datapath gateway 200. Information corresponding to a device of the one or more devices may include, but is not limited to a location information of the device, a data requested by the device, a data downloaded by the device, a data uploaded by the device, and a data browsed by the device. Extraction of information is explained in detail in conjunction with FIG. 4.

At step 302, processor 204 associates the one or more contents with one or more headers corresponding to the one or more data packets. The one or more contents may be associated with the one or more headers based on information extracted for the one or more devices. In an embodiment, the one or more contents are associated with the one or more headers by inserting the one or more contents in one or more of the one or more headers. The one or more contents may include one or more of, but are not limited to advertisements, news articles, weather reports, a location based information, and a multimedia presentation.

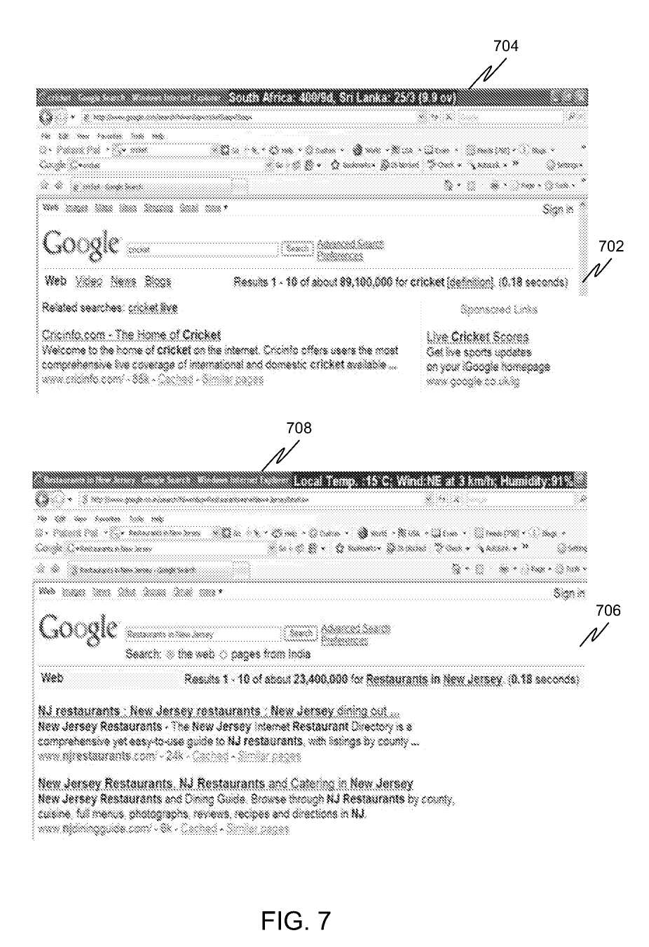

Thereafter, at step 304, processor 204 renders the one or more contents with data represented by the one or more data packets. In an exemplary embodiment, a user sends a request for a website by using device 112 to data server 108 through anchor datapath gateway 200. Transceiver 202 receives one or more data packets transmitted for device 112 at anchor datapath gateway 200. The one or more data packets are transmitted by data server 108 in response to the request. The one or more data packets correspond to the website requested by the user. Processor 204 in anchor datapath gateway 200 then associates one or more advertisements to one or more headers of the one or more data packets transmitted for device 112. Thereafter, processor 204 renders the website requested by the user on a web page on device 112. Additionally, processor 204 renders the one or more advertisements on a title of the web page. Rendering of the one or more contents is explained in detail in conjunction with FIG. 7.

Displaying the one or more advertisements on the title of the web page avoids blocking a view of a part of the website displayed on the web page. Thus, the one or more advertisements are better received by the user and the chances of ignoring the one or more advertisements by the user are reduced.

FIG. 4 is a flowchart of a method of providing one or more contents in wireless communication network 100, in accordance with another embodiment of the invention. In wireless communication network 100, a set of data packets is communicated between one or more devices and one or more data servers through anchor datapath gateway 200 by transceiver 202. Transceiver 202 receives one or more data packets transmitted for the one or more devices. This has been explained in conjunction with FIG. 3.

At step 402, processor 204 extracts information corresponding to the one or more devices at anchor datapath gateway 200. Information for a device of the one or more devices may be extracted from a set of data packets communicated between the device and the one or more data servers. Alternatively, information for a device of the one or more devices may be extracted from one or more of the one or more data packets. Also, information for a device of the one or more devices may be extracted based on paging information for the device. The paging information of the device is used to track location of the device. The location information of the device may also be retrieved from a pre-configure location database. The pre-configure location database may be located in anchor datapath gateway 200.

Thereafter, based on information extracted for the one or more devices, processor 204 retrieves the one or more contents at step 404. The one or more contents may be retrieved for a device of the one or more devices based on context of a data requested by the device. In an embodiment, the one or more contents are stored in a database. The database may reside in anchor datapath gateway 200. Alternatively, the database may reside outside anchor datapath gateway 200 and may be provided by a third party. At step 406, processor 204 inserts the one or more contents in one or more headers corresponding to the one or more data packets transmitted for the one or more devices. Thereafter, at step 408, processor 204 displays the one or more contents on the one or more devices along with data represented by the one or more data packets.

In an exemplary embodiment, a user sends a request for finding a restaurant in a locality of the user from device 114 to data server 110 through anchor datapath gateway 200. Transceiver 202 receives one or more data packets transmitted for device 114 at anchor datapath gateway 200. The one or more data packets are transmitted by data server 110 in response to the request by device 114 of the user. The one or more data packets correspond to a website showing a list of restaurants in the locality of the user. Processor 204 in anchor datapath gateway 200 then extracts a location information corresponding to device 114 from paging information of device 114. Based on the location information of device 114, processor 204 retrieves a local weather condition information prevailing in the location of device 114, from a database in anchor datapath gateway 200. Thereafter, processor 204 inserts the local weather condition information in one or more headers corresponding to the one or more data packets transmitted for device 114. Processor 204 then displays the website showing the list of restaurants in the locality of the user on a web page on device 114. Additionally, processor 204 displays the local weather condition information prevailing in the location of device 114 on a title of the web page. Displaying the local weather condition prevailing in the location of device 114 of the user might help the user to take a better decision in choosing a restaurant. For example, if the local weather condition is very hot, the user might like to choose a restaurant with indoor eating space. However, if the local weather condition is pleasant, the user might choose a restaurant which serves food on a terrace.

In another exemplary embodiment, a user sends a request for a cricket related website through device 116 of the user, to data server 108 through anchor datapath gateway 200. Transceiver 202 receives one or more data packets transmitted for device 116 at anchor datapath gateway 200. The one or more data packets are transmitted by data server 108 in response to the request by device 116. The one or more data packets correspond to the cricket related website requested by device 116. Processor 204 in anchor datapath gateway 200 then extracts information related to context of the request from the one more data packets transmitted for device 116. Based on context of the request, processor 204 retrieves a schedule of an upcoming cricket match from a database provided by a third party. Thereafter, processor 204 inserts the schedule of the upcoming cricket match in one or more headers corresponding to the one or more data packets transmitted for device 116. Processor 204 then displays the cricket related website on a web page on device 116 of the user. Additionally, processor 204 displays the schedule of the upcoming cricket match on a title of the web page. Displaying the schedule of the upcoming cricket match on the title of the requested cricket related website avoids obfuscating a view of a part of the cricket related website or interfering with a text of the cricket related website. It also increases the chances of capturing the attention of the user as it is related to the context of the cricket related website.

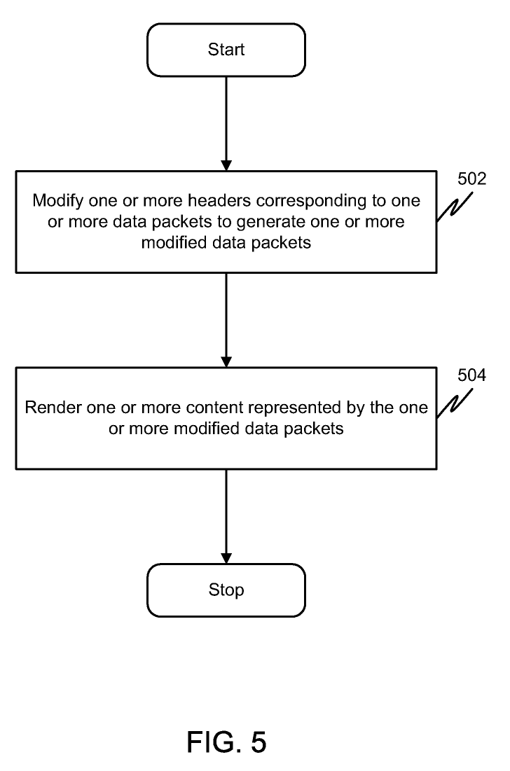

FIG. 5 is a flowchart of a method of communication in wireless communication network 100, in accordance with an embodiment of the invention. In wireless communication network 100, a set of data packets is communicated between one or more devices and one or more data servers through anchor datapath gateway 200. Transceiver 202 receives one or more data packets transmitted for the one or more devices. The one or more data packets may be transmitted from the one or more data servers in response to a data request sent from the one or more devices used by one or more users in wireless communication network 100.

Processor 202 may extract information corresponding to the one or more devices at anchor datapath gateway 200. This has been explained in conjunction with FIG. 4. At step 502, processor 204 modifies one or more headers corresponding to the one or more data packets transmitted for the one or more devices at anchor datapath gateway 200 to generate one or more modified data packets. The one or more headers may be modified based on information extracted for the one or more devices. In an embodiment, the one or more headers are modified by inserting one or more additional contents in one or more of the one or more headers to generate the one or more modified data packets. The one or more additional contents may include one or more of, but not limited to advertisements, news articles, weather reports, a location based information and a multimedia presentation.

Thereafter, at step 504, processor 204 renders one or more contents represented by the one or more modified data packets to the one or more devices in wireless communication network 100.

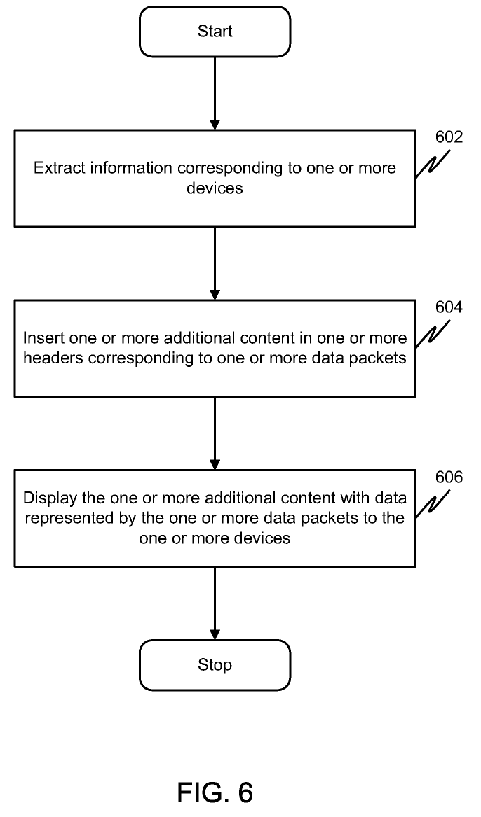

FIG. 6 is a flowchart of a method of communication in wireless communication network 100, in accordance with another embodiment of the invention. Transceiver 202 receives one or more data packets transmitted for one or more devices. This has been explained in conjunction with FIG. 5.

At step 602, processor 204 extracts information corresponding to the one or more devices of the one or more users at anchor datapath gateway 200. This has been explained in conjunction with FIG. 4.

Thereafter, at step 604, processor 204 inserts one or more additional contents in one or more headers corresponding to the one or more data packets to generate one or more modified data packets. Processor 204 inserts the one or more additional contents in the one or more headers based on information extracted for the one or more devices. In an embodiment, the one or more additional contents are stored in a database.

Finally, at step 606, processor 204 displays the one or more additional contents along with a data represented by the one or more data packets on the one or more devices in wireless communication network 100. For example, if the a user of a device requested a webpage, then processor 204 displays the one or more additional content on a title of the web page. This has been explained in conjunction with FIG. 4.

FIG. 7 illustrates a method of displaying one or more contents on one or more devices in wireless communication network 100, in accordance with an exemplary embodiment of the invention. A user sends a request for a data related to cricket to data server 110 from device 118. Device 118 is a mobile phone of the user. The user sends the request to data server 110 by typing “cricket” on the website www.google.com, displayed on device 112.

In response to the request, data server 110 transmits one or more data packets to device 112. Based on the one or more data packets, processor 204 at anchor datapath gateway 200 determines that the request by the user is related to cricket. Subsequently, processor 204 inserts a schedule of an upcoming cricket match in one or more headers of the one or more data packets. Processor 204 then displays data represented by the one or more data packets to device 118 of the user on a webpage 702. Additionally, processor 204 renders the schedule of the upcoming cricket match on a title 704 of webpage 702.

In another instance, a user sends a request for a data related to restaurants in New Jersey to data server 108 from device 114. Device 114 is a PDA of the user. The user sends the request to data server 108 by typing “restaurants in New Jersey” on the website www.google.com displayed on device 114.

In response to the request, data server 108 transmits one or more data packets to device 114. Processor 204 in anchor datapath gateway 200 extracts a location of device 114 from paging information of device 114. Based on the location information of device 114, processor 204 inserts a local weather information prevailing in the location of device 114 in one or more headers of the one or more data packets transmitted by data server 108 for device 114. Thereafter, processor 204 displays data represented by the one or more data packets to device 114 on a webpage 706. Additionally, processor 204 displays the local weather information on a title 708 of webpage 706.

Various embodiments of the invention provide method and apparatuses to provide one or more contents to one or more devices in a wireless communication network. The one or more contents are provided based on a context of a data request by the one or more devices and the location information of the one or more devices. Additionally, the one or more contents are displayed, such that, they do not interfere with the requested data.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of providing at least one content to at least one device in a wireless communication network, the method comprising:
associating the at least one content with at least one header corresponding to at least one data packet transmitted for the at least one device at an anchor datapath gateway in the wireless communication network; and
rendering the at least one content with data represented by the at least one data packet to the at least one device in response to associating the at least one content with the at least one header.

2. The method of claim 1, wherein associating comprises inserting the at least one content in a header of the at least one header.

3. The method of claim 1, wherein the at least one content comprises at least one of advertisements, news articles, weather reports, a location based information and a multimedia presentation.

4. The method of claim 1, wherein rendering comprises displaying the at least one content on a title of a requested web page.

5. The method of claim 1 further comprising extracting information corresponding to the at least one device.

6. The method of claim 5, wherein information for a device of the at least one device is extracted from at least one of the at least one data packet.

7. The method of claim 5, wherein information for a device of the at least one device is extracted from a set of data packets communicated between the device and at least one data server.

8. The method of claim 5, wherein information for a device of the at least one device is extracted based on paging information of the device.

9. The method of claim 5, wherein a content of the at least one content is associated with a header of the at least one header corresponding to a data packet of the at least one data packet transmitted for a device of the at least one device based on information extracted for the device.

10. The method of claim 5, wherein information corresponding to a device of the at least one device comprises at least one of a location information of the device, a data requested by the device, a data downloaded by the device, a data uploaded by the device, and a data browsed by the device.

11. The method of claim 1 further comprising retrieving the at least one content.

12. The method of claim 1, wherein the at least one content is stored in a database.

13. The method of claim 1, wherein each device of the at least one device is one of a mobile phone, a PDA, a smart phone and a pager.

14. The method of claim 1, wherein the wireless communication network is one of a Worldwide Interoperability for Microwave Access (WiMAX) communication network, 3rd Generation Partnership Project (3GPP) Long Term Evolution (LTE) network, 3rd Generation Partnership Project 2 (3GPP2) Ultra Mobile Broadband (UMB) network, Wireless Fidelity (WiFi) network, and Orthogonal Frequency Division Multiple Access (OFDMA) communication network having a backhaul link.

15. A method of communication in a wireless communication network, the method comprising:
modifying at least one header corresponding to at least one data packet transmitted for at least one device at an anchor datapath gateway in the wireless communication network to generate at least one modified data packet;
rendering at least one content represented by the at least one modified data packet on the at least one device.

16. The method of claim 15, wherein modifying comprises inserting at least one additional content in a header of the at least one header.

17. The method of claim 16, wherein the at least one additional content comprises at least one of advertisements, news articles, weather reports, a location based information and a multimedia presentation

18. The method of claim 16, wherein rendering comprises displaying the at least one additional content on a title of a requested web page.

19. The method of claim 15 further comprising extracting information corresponding to the at least one device.

20. An anchor datapath gateway for providing at least one content to at least one device in a wireless communication network, the anchor datapath gateway comprising:
a processor configured to:
associate the at least one content with at least one header corresponding to at least one data packet transmitted for the at least one device in the wireless communication network; and
render the at least one content with data represented by the at least one data packet to the at least one device.
a transceiver coupled to the processor, wherein the transceiver is configured to:
receive the at least one data packet transmitted for the at least one device.

21. The anchor datapath gateway of claim 20, wherein the processor is further configured to extract information corresponding to the at least one device.

22. The anchor datapath gateway of claim 21, wherein the processor is further configured to extract information corresponding to a device of the at least one device from at least one of the at least one data packet.

23. The anchor datapath gateway of claim 21, wherein the processor is further configured to extract information corresponding to a device of the at least one device from a set of data packets communicated between the device and at least one data server.

24. The anchor datapath gateway of claim 21, wherein the processor is further configured to extract information corresponding to a device of the at least one device based on paging information of the device.

25. The anchor datapath gateway of claim 21, wherein the processor is further configured to associate a content of the at least one content with a header of the at least one header corresponding to a data packet of the at least one data packet transmitted for a device of the at least one device based on information extracted for the device.

26. The anchor datapath gateway claim 20, wherein the processor is further configured to retrieve the at least one content.

27. The anchor datapath gateway of claim 20 further comprising a memory configured to store the at least one content.

28. The anchor datapath gateway of claim 27, wherein the memory is further configured to store information extracted corresponding to the at least one device.
